(19) United States
(12) Patent Application Publication
(10) Pub. No.: US 2025/0146336 A1
(43) Pub. Date: May 8, 2025

(54) LOCKING SYSTEM FOR A VEHICLE SLIDE OUT TRAY SYSTEM

(71) Applicant: Adrian Steel Company, Adrian, MI (US)

(72) Inventors: Alexander James Mohn, Boise, ID (US); Michael Joseph Evans, Caldwell, ID (US); Peter Francis Rowlson, Addison, MI (US); Joshua Merle Rogers, Adrian, MI (US)

(73) Assignee: Adrian Steel Company, Adrian, MI (US)

(21) Appl. No.: 18/931,745

(22) Filed: Oct. 30, 2024

Related U.S. Application Data
(60) Provisional application No. 63/595,814, filed on Nov. 3, 2023.

(51) Int. Cl. E05B 83/00; B62D 33/08

(52) U.S. Cl. CPC E05B 83/00; B62D 33/08

(57) ABSTRACT

A locking mechanism for a slide out tray system may have a cam that is connected to a lock rod. A lock bar lever may be rotatable about an offset portion, such that when the cam is rotated, the end of the lock bar lever in contact with the cam is pushed upwards, thus pushing the opposite end of the lock bar lever downwards to push the locking plate down, allowing the slide out tray system to slide into a closed position. A bushing lock may interact with lock rod flanges. The lock rod flanges roll over and are supported by a bushing. When the bushing meets a space between the lock rod flanges, the lock rod may automatically rotate such that the flange contacts an edge of the bushing lock, thus preventing the lock rod and tray system from extending any further.

### FIELD

A locking system for a slide out tray system is provided. The slide out tray system may be for, but is not limited to, a truck bed.

### BACKGROUND

Slide out tray systems allow for easier access to equipment stored in the bed of a truck by extending out of the truck bed and into a more accessible position. An issue with the slide out tray systems, however, is that when the vehicle to which it is fixed is parked on an incline, the slide out tray system may rapidly and forcefully retract into the truck bed or extend out of the truck bed. This can be a safety hazard as the slide out tray systems are often loaded with heavy equipment and machinery.

Prior art locking systems exist, but they are overly complex with too many failure modes, and they are difficult to manufacture and install on the slide out tray system, which drives up expense.

In view of the hazardous nature of the slide out tray systems and the disadvantages with the known solutions, it would be advantageous to have a simple method of locking the slide out tray system in place to prevent the rails of the slide out tray systems from dangerous, unwanted extension and regression.

### SUMMARY

In one aspect, a locking mechanism for a slide out tray system may have a cam that is directly connected to and extends perpendicular to a lock rod. The lock rod may have multiple, rectangular and planar flanges that are spaced apart from one another along the lock rod. The locking mechanism may also have a lock bar lever that has an inboard portion and an outboard portion. The inboard portion may have a lock bar lever flange on a lower surface of the inboard portion, and a lower wall of the outboard portion of the lock bar lever may be in pivotable contact with an upper, arc shaped portion of the cam. The locking mechanism may also have a locking plate that has a first portion and a second portion. The first portion of the locking plate may have an upper surface and a lower surface, and a front-end portion and a rear-end portion, with the rear end portion being connected to the second portion of the locking plate by a hinge. The second portion of the locking plate may be fixed to an anchor frame, which may be part of a fixed frame. The fixed frame may be fixed to a truck bed. The lock bar lever flange may be adapted to contact the upper surface of the first portion at the front end of the locking plate.

In another aspect, the second portion of the locking plate may be planar with an X and Z plane, while the first portion of the locking plate may be angled towards the Y axis.

In another aspect, the inboard portion and the outboard portion of the lock bar lever may be separated by a midline of the lock bar lever. The lock bar lever may be tapered toward the inboard portion and pivotable about an offset position that is on the inboard portion of the lock bar lever.

In another aspect, a skid plate may be perpendicular to the lock bar lever and parallel to the first portion of the locking plate such that the first portion of the locking plate is adapted to make selective contact with the skid plate.

In another aspect, a bushing lock may be fixed to the fixed frame. The bushing lock may have a bushing, a bushing casing, and a lock angle. The bushing casing may be directly attached to an upper portion of the lock angle and may be adapted to receive a supporting element, such as a bolt, that supports a bushing. The long edge of the rectangular lock rod flanges may be adapted to make slidable contact with the bushing, while the short edges of the rectangular lock rod flanges may be adapted to make stationary contact with the upper portion of the lock angle when the long edges of the lock rod flanges are not in contact with the bushing.

In another aspect, a locking mechanism for a slide out tray system may have a cam that is directly connected to a lock rod, a cam face and a covered cam face that are parallel to one another, and an arced upper portion. The locking mechanism may also have a lock bar lever that has an inboard portion and an outboard portion. The outboard portion may have a lower wall that is in pivotable contact with the arced upper portion of the cam.

In another aspect, a locking mechanism for a slide out tray system may have a lock bar lever that has a lock bar lever flange on a tapered, inboard portion of the lock bar lever. The locking mechanism may also have a locking plate with a first portion and a second portion, with the first portion having a front portion and a rear portion. The first portion of the locking plate may be connected to the second portion at the rear-end portion by a spring hinge. The first portion of the locking plate may be angled upward toward the Y axis relative to the second portion of the locking plate, and the lock bar lever flange may make selective contact with the front-end portion of the first portion of the locking plate.

In another aspect, a locking mechanism for a slide out tray system may have a lock rod that is rotatable and has rectangular lock rod flanges that are cantilevered from the lock rod. The rectangular lock rod flanges may each have a long edge that is parallel to the X axis and a short edge that is perpendicular to the X axis, and the lock rod flanges may be arranged on the lock rod such that spaces exist between each lock rod flange. The locking mechanism may have a lock angle, a bushing, and a bushing casing. The bushing casing may be directly attached to an upper portion of the lock angle and adapted to receive a supporting element. The supporting element may support the bushing. The long edges of the lock rod flanges may make slidable contact with the bushing and the short edges of the lock rod flanges are adapted to make stationary contact with the upper portion of the lock angle when the long edges of the lock rod flanges are not in contact with the bushing.

In another aspect, the supporting element may be a bolt.

In another aspect, the lock rod flanges may be parallel with one another.

In another aspect, the lock angle may be rigid and fixed to a fixed frame.

In another aspect, the lock angle may extend longitudinally perpendicular to the X axis.

### BRIEF DESCRIPTION OF THE DRAWINGS

The above, as well as other advantages, will become readily apparent to those skilled in the art from the following detailed description when considered in the light of the accompanying drawings in which:

FIG. 1 is a top view of one embodiment of a slide out tray system in a non-extended condition;

FIG. 2 is a top view of one embodiment of the slide out tray system from FIG. 1 in a fully extended condition;

FIG. 3 is a perspective view of the slide out tray system from FIG. 1 where the slide out tray system has been locked by a locking mechanism in the fully extended position;

FIG. 4 is a side view of the slide out tray system from FIG. 1 in the non-extended position;

FIG. 5 is a perspective, close up view of the slide out tray system from FIG. 1 showing a cam, cam guard, lock bar lever, and lock rod from the front in the non-extended position;

FIG. 6 is a rear view of the lock bar lever, the cam, and the cam guard in a non-actuated position;

FIG. 7 is a rear view of the cam and cam guard;

FIG. 8 is a perspective, close up view of the locking mechanism;

FIG. 9 is a perspective view of a locking plate sliding underneath a skid plate while the slide out tray system is between the fully extended position and the non-extended position;

FIG. 10A is an overall view of the locking mechanism of FIG. 8 in an actuated position;

FIG. 10B is a detailed view of the locking mechanism of FIG. 8 in an actuated position;

FIG. 11 is a perspective view of a bushing locking system between flanges of the lock bar lever;

FIG. 12 is a perspective view of the bushing locking system from FIG. 11 showing the flanges of the lock bar lever in rolling contact with the bushing.

### DETAILED DESCRIPTION OF THE PREFERRED EMBODIMENTS

It is to be understood that the device and/or method described and depicted herein may assume various alternative orientations and step sequences, except where expressly specified to the contrary. It is also to be understood that the specific devices and processes illustrated in the attached drawings, and described in the following specification are simply exemplary embodiments. Hence, specific dimensions, directions or other physical characteristics relating to the embodiments disclosed are not to be considered as limiting, unless expressly stated otherwise.

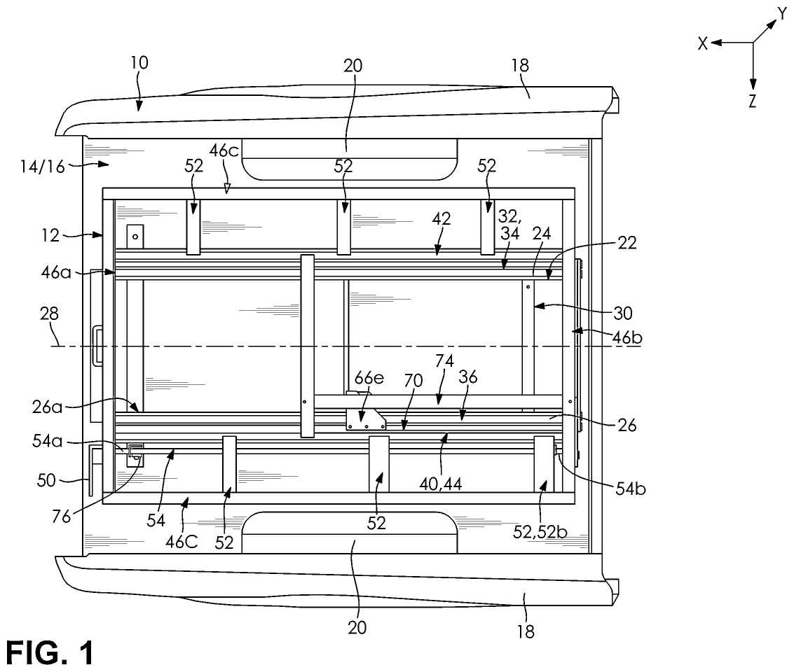

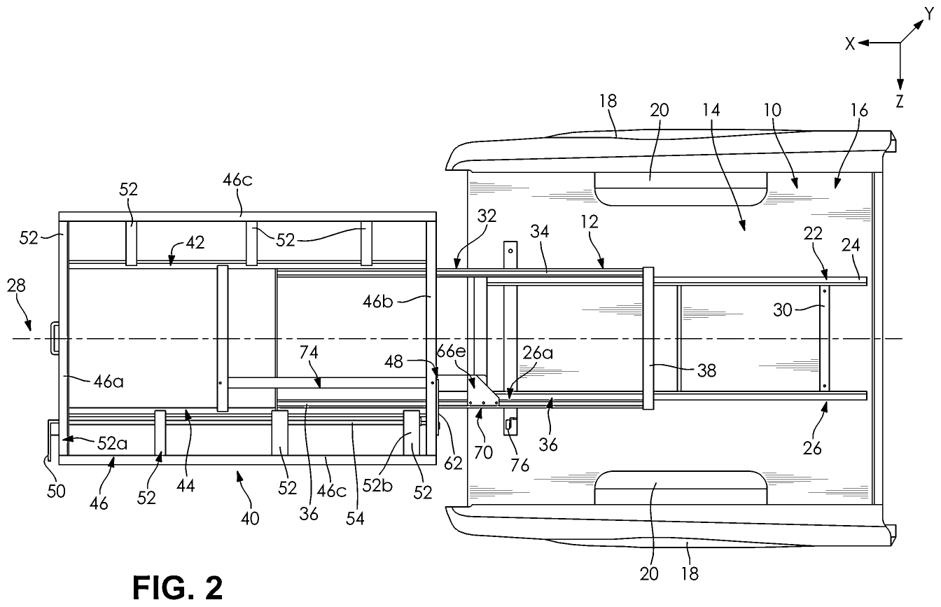

Turning now to FIGS. 1-2, one embodiment of a partial vehicle 10 with one embodiment of a slide out tray system 12 is depicted from above. The partial vehicle 10 may be such as a pickup truck. While a pickup truck is mentioned, other vehicles may be used as well including, but not limited to, cargo vans and utility type vehicles. Further, while a vehicle 10 is depicted, a vehicle 10 is not required. Instead, the slide out tray system 12 may be used in a stationary, or non-vehicular, application.

Continuing with the exemplary discussion of the system 12 located in a pickup truck 10, a truck bed 14 may extend along an X axis. The X axis may be defined as the direction of typical forward and rearward movement of a vehicle. A Z axis may run perpendicular to the direction of travel of the vehicle, and thus may be perpendicular to the X axis. Finally, a Y axis may run vertically perpendicular to both the X and the Z axis.

The bed 14 of the truck 10 may be provided with a floor 16, two generally parallel side walls 18, a front wall (not seen) and a tailgate (not seen but may or may not be present at all). The side walls 18 may extend in a generally perpendicular fashion along the Y axis upwardly from the floor 16. Wheel wells 20 may be part of the side walls 18 and/or the floor 16.

Turning now to FIGS. 1-3, the slide out tray system 12 may have a fixed frame 22. The fixed frame 22 may be attached to the bed 14, such as the floor 16. As such the fixed frame 22 may be the lowermost and inner most structure of the system 12. The attachment may be through mechanical fasteners. The fixed frame 22 may generally extend the length of the bed 14. In one embodiment, the fixed frame 22 may terminate adjacent the tailgate.

The fixed frame 22 may have a first fixed rail 24 and a second fixed rail 26, and the fixed rails 24, 26 may extend generally parallel one another. The fixed rails 24, 26 may extend parallel, and generally equal distance apart from, a longitudinal axis 28 of the bed 14, which may also be the longitudinal axis 28 of the system 12. The longitudinal axis 28 of the system 12 may be parallel to the X axis.

In one embodiment, the first and second fixed rails 24, 26 may have a general C-shaped cross-section with the C openings facing opposite directions from one another and the longitudinal axis 28. The C-shaped cross-sections may be adapted to receive rollers (not shown) therein and to permit the rollers to roll within the C-shapes substantially along their longitudinal lengths.

The fixed frame 22 may also have one or more lateral supports 30 extending along the Z axis between the first and second fixed rails 24, 26. The laterals supports 30 maintain the position of the fixed rails 24, 26 with respect to one another and the bed 14 and stiffen the fixed frame 22.

The system may also be comprised of a first slide frame 32. The first slide frame 32 may selectively slide along the fixed frame 22 in the longitudinal direction along the X axis.

The first slide frame 32 may have a first slide rail 34 and a second slide rail 36. Rollers, such as those mentioned above, may be attached to both the first slide rail 34 and the second slide rail 36. The rollers may be attached along the lengths of the respective rails 34, 36. The rollers, being adapted to fit within the first and second fixed rails 24, 26, locate the first slide rail 34 and the second slide rail 36 adjacent the first and second fixed rails 24, 26, respectively. The first slide frame 32 may have lateral supports 38 connected the first and second slide rails 34, 36 so that the rails 34, 36 move together and to provide strength and stiffness to the first slide frame 32.

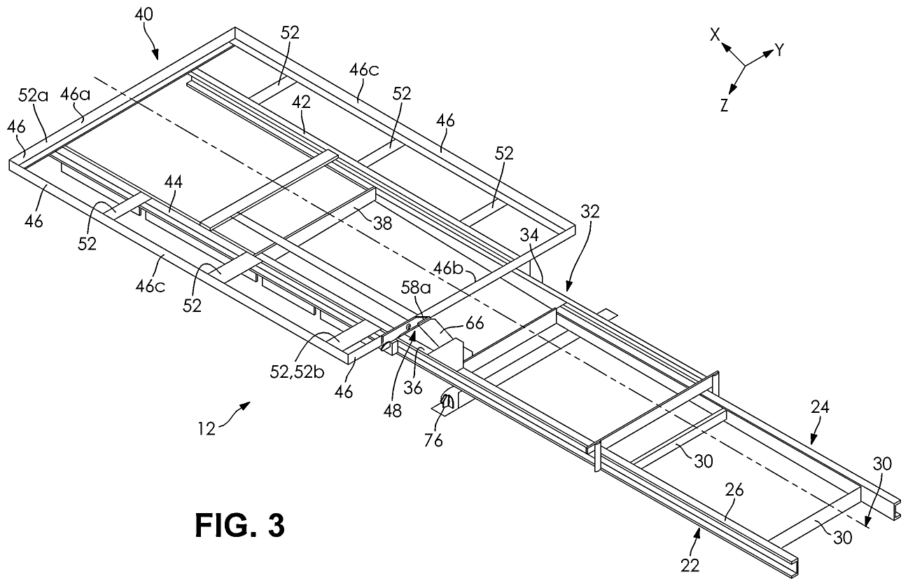

In a retracted position, depicted in FIG. 1, the first slide frame 32 may be located substantially adjacent the fixed frame 22 such as in a laterally bounding, or nested, position. The first slide frame 32 may be longitudinally extended along the X axis from the fixed frame 22 by any distance. It can be appreciated that longitudinal extension of the first slide frame 32 with respect to the fixed frame 22 may locate the first slide frame 32 at least partially out of the bed 14, as shown in FIG. 2. In the embodiments depicted in FIGS. 2 and 3, the first slide frame 32 may be located in a partially overlapping and a partially non-overlapping position with the fixed frame 22 even in the fully extended position of the first slide frame 32. The first slide frame 32 may also be located in a partially overlapping and a partially non-overlapping position with the bed 14 and/or tailgate even in the fully extended position of the first slide frame 32.

In one embodiment, the first and second slide rails 34, 36 may have a general C-shaped cross-section with the C openings facing one another toward the longitudinal axis 28. Rollers (not shown) may be mounted on the outside surfaces of the first and second slide rails 34, 36.

In some embodiments, the system 12 may also comprise a second slide frame 40. The second slide frame 40 may have a first slide rail 42 and a second slide rail 44. The first and second slide rails 42, 44 of the second slide frame 40 may have a general C-shaped cross-section with the C openings facing opposite one another, such as toward their respective adjacent bed side walls. The C-shapes of the rails of the second slide frame 40 are adapted to receive the rollers (not shown) attached to the first slide frame 32. Thus, the first slide rails 34, 42 and the second slide rails 36, 44 of the first and second slide frames 32, 40, respectively, may be designed to selectively cooperate, and may nest, with respect to one another.

The second slide frame 40 may be longitudinally extended from the first slide frame 32 by any distance. It can be appreciated that longitudinal extension of the second slide frame 40 with respect to the first frame 32 may locate the second slide frame 40 at least partially out of the bed 14, as shown in FIGS. 2 and 3. In the embodiments depicted in FIGS. 2 and 3, the second slide frame 40 may be located in a partially overlapping and partially non-overlapping position with the first slide frame 32 even in the fully extended position of the second slide frame 40.

While a first and second slide frame 32, 40 are mentioned, it may be that the system only has a first slide frame 32. The following will discuss both a first and a second slide frame 32, 40, but it may be appreciated that the devices and processes below may be equally adapted to only a first slide frame 32 and a fixed frame 22. Similarly, it may also be appreciated that additional slide frames may be used in addition to a second slide frame 40. Here also the following discussion of devices and processes applies to systems with additional slide frames.

The second slide frame 40 may also have perimeter members 46 attached to the first and second slide rails 42, 44. The perimeter members 46 may comprise front and rear members 46a, 46b, as well as two parallel side members 46c connected to the front and rear members 46a, 46b. The perimeter members 46 may connect together to generally form a rectangular shape. The perimeter members 46 may extend laterally and longitudinally beyond the first and second slide rails 42, 44 as they may support a tray or other related structure.

In some embodiments, it may be preferred to secure or lock the second slide frame 40 with respect to the first slide frame 32. Further, it may be preferred to lock the second slide frame 40 with respect to the first slide frame 32 when the second slide frame 40 is fully extended from the first slide frame 32. In the full extension position, the present system may advantageously locate the second slide frame 40 beyond the truck bed 14 and perhaps the tail gate as well. In one condition, the second slide frame 40 may be located 5-15 percent of the length of the bed 14 outside of the truck bed 14. In a preferred condition, the second slide frame 40 may be located about 10 percent of the length of the bed 14 outside of the truck bed 14. By way of one example, in some embodiments of the full extension position, the rear perimeter member 46b may be distal from the truck bed 14 by between four and seventeen inches. One reason to locate the second slide frame 40 in this extended position is that it is often desirable to access the contents of the second slide frame 40 about the perimeter of the second slide frame 40 without restriction from the bed 14. For example, a tray, cabinets, shelves, equipment, tools and items may be associated with the second slide frame 40 and having full access to them about the perimeter of the second slide frame 40 is desirable.

To lock the second slide frame 40 with respect to the first slide frame 32 a locking system 48 is provided. At least FIGS. 1-10 depict certain aspects of the locking system 48 discussed below. One aspect of the locking system 48 may be a handle 50. The handle 50 may be mounted for selectively pivotal movement on or in a longitudinally distal lateral support member 52a of the second slide frame 40 in such a way that allows a user to actuate the handle 50, and thus the locking system 48, from outside the truck bed 14 including longitudinally behind the truck bed 14, the first slide frame 32, and the second slide frame 40.

The handle 50 may be of any shape or size as long as a user is capable of grasping it with their hand and imparting a rotational force to the handle 50. In one embodiment, the handle 50 may be located to one side of the longitudinal axis 28.

The handle 50 may be connected, such as directly attached to, a lock rod 54. As such, a first end portion 54a of the lock rod 54 may extend through the distal lateral support member 52a to connect with the handle.

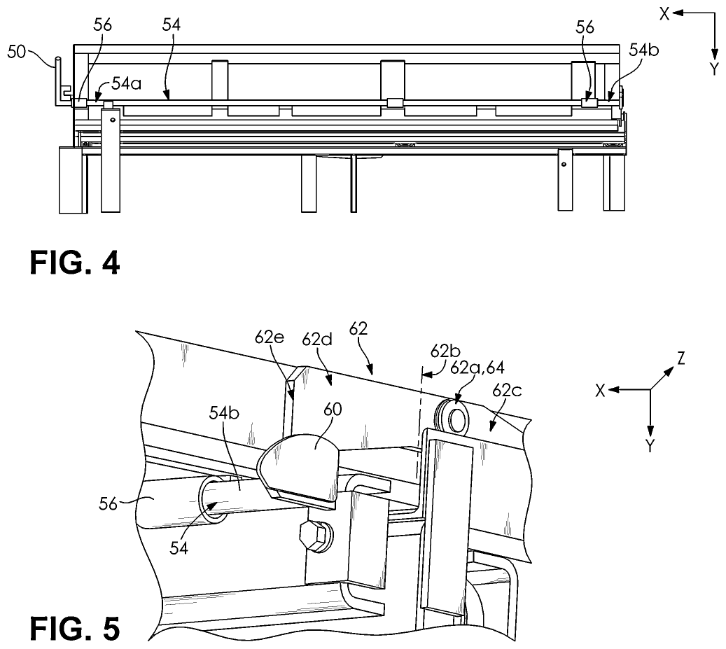

In one case, the lock rod 54 may be one piece, unitary and integrally formed. The lock rod 54 may also generally extend the longitudinal length of the second slide frame 40 from the distal lateral support member 52a to an inner lateral support member 52b of the second slide frame 40. In such a condition, the lock rod 54 may extend generally parallel the longitudinal axis 28. The lock rod 54 may have at least one lock rod flange 54d that is cantilevered from and perpendicular to the lock rod 54. If multiple lock rod flanges 54d are used, the lock rod flanges 54d may be of generally equal width and may be located along the lock rod 54 in an organized manner with equal spaces between one another, or the lock rod flanges 54d may be located along the lock rod 54 in a randomized way with varying spaces between one another. The lock rod flanges 54d may comprise long, longitudinal sides 54e that are parallel to the X axis and short, lateral sides 54f that are perpendicular to the X axis and that are shorter than the longitudinal sides 54e, thus forming a rectangular shape. The lock rod 54 may be supported in tubes 56 attached to the second slide frame 40. In one example seen in FIG. 4, the lock rod 54 may be slid into a series of aligned support tubes 56 that rotationally support the lock rod 54 therein.

It may be possible, however, for the lock rod 54 to be comprised of more than one piece. In this construction, the lock rod 54 may be comprised of one or more longitudinally connecting components that are attached together and adapted to transmit the rotational force from the handle 50 at the distal lateral support member 52a to the inner lateral support member 52b.

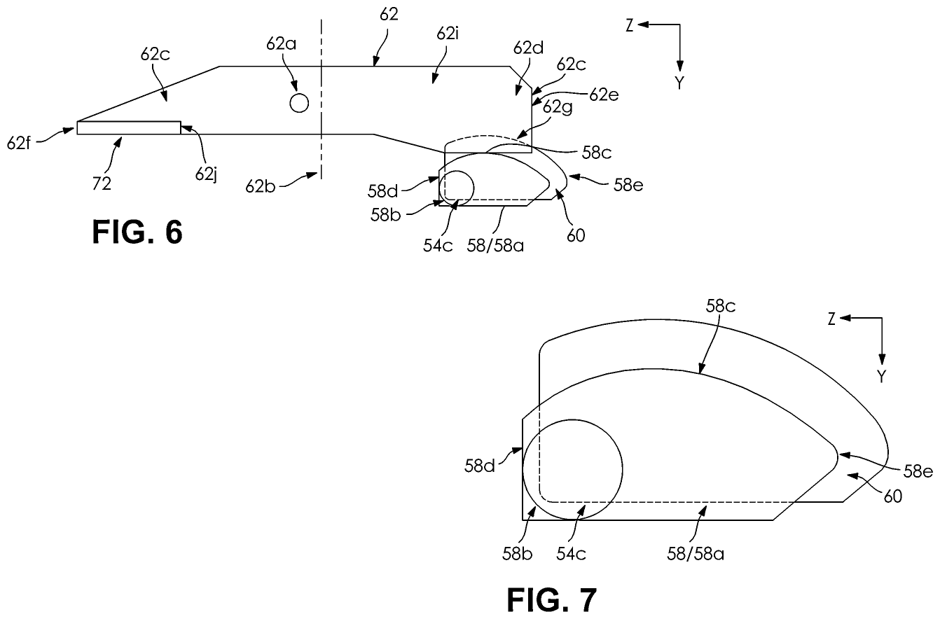

A second end portion of the lock rod 54b may be connected to a cam 58, one embodiment of which is seen in at least FIGS. 5-7. The cam may have a cam face 58a and a covered cam face (not shown) that are parallel one another. The connection may be such as a direct connection where an end surface 54c of the lock rod 54 abuts the cam face 58a. As may be seen in FIGS. 6 and 7, the lock rod 54 may abut the cam face 58a at a lower inboard (e.g. closer to the longitudinal axis) surface 58b of the cam 58 in such a way that the lock rod is perpendicular to the cam. The end surface 54c of the lock rod 54 may be welded to the cam face 58a so that rotation of the lock rod 54 results in a direct and equal rotation of the cam 58. In one case, the lock rod 54 and cam 58 may be cantilevered from one of the support tubes 56. The general extension direction of the cam 58 may be substantially transverse the general extension direction of the lock rod 54 and the cam 58 may be generally planar.

The cam 58 may have an upper surface 58c. The upper surface 58c may have an arc shape that extends between a tall, inboard base portion 58d and a short, outboard (distal the longitudinal axis) point portion 58e, best seen in FIG. 5-7. The arc provides the cam a flat end 58f and a pointed end 58e. The arc also makes the cam 58 non-symmetrical.

FIGS. 6-7 also depict one embodiment where a cam guard 60 is located adjacent the cam 58. The cam guard 60 may be directly attached to the cam 58 but in some cases there may be a shim or other structure between them. The shim may be used to provide spacing between the cam guard 60 and the cam 58 to position the cam guard 60 with respect to a lock bar lever 62. The cam guard 60 may have a similar shape to the cam 58 but it may be larger and/or vertically and/or laterally offset with respect to the cam 58, as may be best seen in FIGS. 6-7. The cam guard 60 may function to reinforce and stiffen the cam 58 as well as provide a guiding surface for the lock bar lever 62. The cam guard 60 may extend generally parallel the cam 58 and the cam guard 60 may be generally planar.

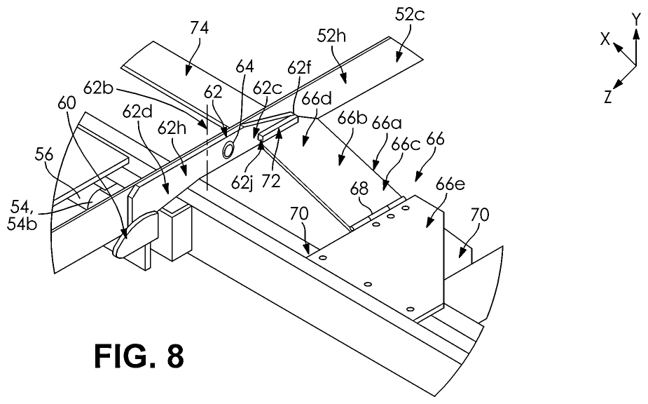

One embodiment of a lock bar lever 62 is depicted in FIG. 6, which depicts the a rear surface 62i of the lock bar lever 62, and FIG. 8, which depicts a rear perspective view of the lock bar lever 62. The general extension direction of the lock bar lever 62 may be along the Z axis, such as substantially parallel the general extension direction of the cam 58. In other words, the general extension direction of the lock bar lever 62 may be substantially transverse the general extension direction of the lock rod 54.

The lock bar lever 62 may be connected to perimeter member 46b of the second slide frame 40. While one possible connection to the inner lateral member 52b is mentioned, other connections to other components of the second slide frame 40 may be possible. As shown in FIGS. 2 and 8, the lock bar lever 62 may be positioned generally parallel the inner lateral support member 52b, and off to one side of the longitudinal axis 28. The connection of the lock bar lever 62 to the inner lateral support member 52b may be such as through a pivotal connection. For example, a fastener 64 may extend through the inner lateral support member 52b and the lock bar lever 62. The fastener 64 may be located at approximately an offset position 62a with respect to a mid-line 62b of the lock bar lever 62. In some cases, the offset position 62a may be more toward the longitudinal axis 28. The lock bar lever 62 may have an inboard portion 62c and an outboard portion 62d; the offset position 62a may be located on the inboard portion 62c of the lock bar lever 62.

The inboard portion 62c may be generally tapered away from the outboard portion 62d. The lock bar lever 62 may also be generally tapered toward the inboard portion thus providing the outboard portion 62d with an outboard wall 62e that has a greater vertical dimension than an inboard wall 62f of the inboard portion 62c. In other words, the outboard portion 62d may have a lower wall 62g that is angled into the lock bar lever 62 decreasing its vertical height towards the inboard portion 62c. The lower wall 62g may be in direct contact with the cam surface 58c.

The lock bar lever 62 may have a forward surface 62h and a rear surface 62i that generally define a substantially constant thickness between them. The forward and rear surfaces 62h, 62i may be generally parallel one another.

The lock bar lever 62 may be located above the second slide rail 44 of the second slide frame 40 and the lock bar lever 62 may also span over second slide rail 36 of the first slide frame 32, which may be appreciated from at least FIGS. 2, 3, and 10.

The inboard portion 62c may be in selective contact with a first portion 66a of a locking plate 66. In some embodiments a lock bar lever flange 72 located on a lower surface 62j of the inboard portion 62c of the lock bar lever 62 may make selective contact with an upper surface 66b of the first portion 66a of the locking plate 66. More particularly, the lock bar lever flange 72 may make selective contact with a front end portion 66d of the upper surface 66b of the first portion 66a of the locking plate 66. The first portion 66a of the locking plate 66 may have the upper surface 66b and a lower surface (not shown). The two surfaces may be separated by a relatively constant thickness such that the two surfaces may be generally parallel one another. The general extension direction of the first portion 66a of the locking plate 66 may be substantially transverse the general extension direction of the lock bar lever 62, or in other words generally parallel the longitudinal axis 28.

The first portion 66a of the locking plate 66 may also have a rear end portion 66c. The rear end portion 66c may be pivotally attached to a second portion 66e of the locking plate 66. The pivotal attachment may be such as through a hinge 68. The hinge 68 may be such as a spring hinge 68, or a biasing member may be connected to the first portion 66a to bias the first portion 66a as noted below. In any case, the first portion 66a of the locking plate 66 is biased upwardly relative to the second portion of the locking plate towards the Y axis. By way of one example, the upward angle the first portion 66a may be located at may be between 5-25 degrees from horizontal.

The second portion 66e of the locking plate 66 may be generally oriented in a substantially horizontal orientation such that it is planar in an X and Z plane. Further, the second portion 66e of the locking plate 66 may be fixed; thus the first portion 66a may be adapted to move with respect to the fixed second portion 66e.

The second portion 66e may be connected to an anchor frame 70 which may be part of the fixed frame 22. The connection may be through such as welding and/or fasteners. In one embodiment, the anchor frame 70 may at least partially vertically overlap the second portion 66e. The anchor frame 70 may be attached to the second slide frame 40 for movement therewith as seen in at least FIG. 3.

FIGS. 3, 8, 9, and 10 also depict the embodiment in which the first portion 66a of the locking plate 66 is biased upwardly. The front end portion 66d of the locking plate 66 may be in direct contact with a rear surface 52c of the inner lateral support member 52b of the second slide frame 40. In this condition the second slide frame 40 may be fully extended, such as out of the vehicle bed 14. The locking plate 66 may prevent the second slide frame 40 from retracting in a longitudinally rearward direction, such as back into the vehicle bed 14.

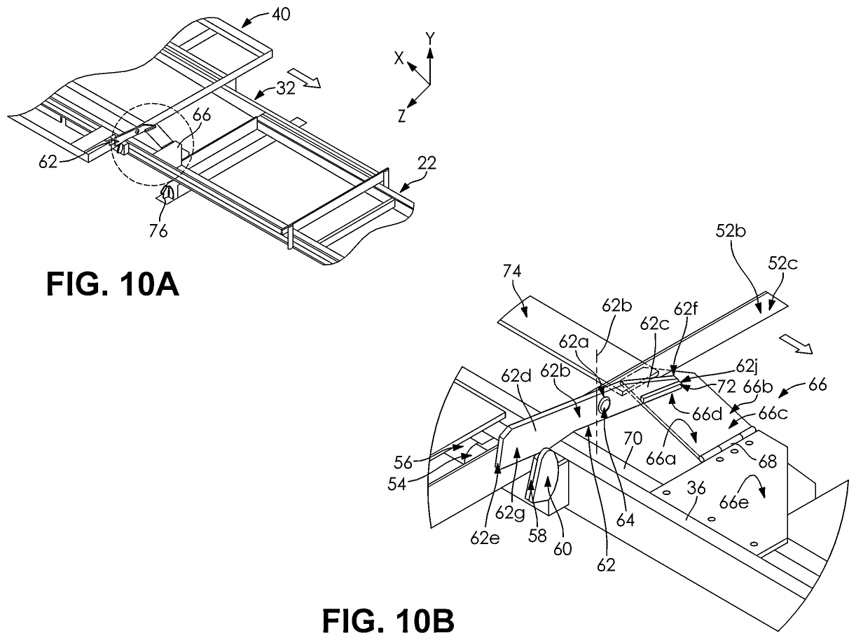

Should the second slide frame 40 be desired to be retracted into the vehicle bed 14, the handle 50 can be first rotated. Rotation of the handle 50 simultaneously rotates the lock rod 54, which simultaneously pivots the cam 58 connected to the lock rod 54. As shown in FIGS. 10a and 10b, the outboard portion 58e of the cam 58 has pivoted up and the inboard portion 58d of the cam 58 has pivoted down. Simultaneously, the outboard portion 62d of the lock bar lever 62 has pivoted up and the inboard portion 62c of the lock bar lever 62 has pivoted down.

The lock bar lever flange 72 pushes the first portion 66a of the locking plate 66 down against the biasing force. The first portion 66a of the locking plate 66 is pushed downwardly below the inner lateral support member 52b of the second slide frame 40. With the locking plate 66 no longer blocking the rearward path of the second slide frame 40, the second slide frame 40 may be moved longitudinally rearwardly into the vehicle bed 14.

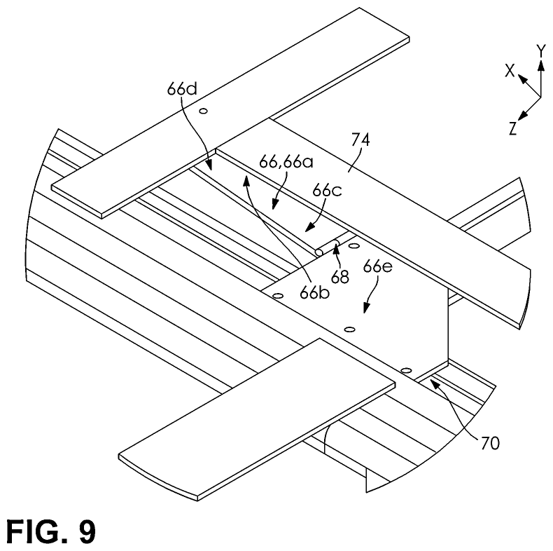

The first portion 66a of the locking plate 66 moves under the inner lateral support member 52b of the second slide frame 40 where it encounters a skid plate 74 attached to the second slide frame 40. The skid plate 74 may be a planar member that generally extends parallel the longitudinal axis 28 under the second slide frame 40. In other words, the skid plate 74 may extend perpendicular to the lock bar lever 62 and parallel to the first portion of the locking plate 66 along the X axis. Being biased upwardly, the first portion 66a of the locking plate 66 may slide along in selective contact with the skid plate 74 as the second slide frame 40 is moved longitudinally inwardly/rearwardly into the bed 14, which may be appreciated from FIGS. 9-10. As the skid plate 74 is holding the locking plate 66 down and the locking plate 66 has passed the lock bar lever 62, the handle 50 may be released.

When the second slide frame 40 and the first slide frame 32 are located within the bed 14, and they are generally coextensive with one another as shown in FIG. 1. The lock bar lever 62 may be generally aligned, such as generally coplanar with, an end portion of the second rail 26a of the fixed frame 22, as shown in FIG. 1. In such a condition, the first slide frame 32 and second slide frame 40 may be located substantially adjacent along the fixed frame 22 such as in a laterally bounding, or nested, position.

While the above describes a way to lock the slide out tray system 12 in a way that prevents the slide out tray system 12 from sliding back in towards the truck bed 14, it may also be desirable to prevent the slide out tray system 12 from sliding fully out of the truck bed 14. In such a case, a bushing lock system 76 comprising a lock angle 78, a bushing casing 80, and a bushing 86 may be employed

In one embodiment, as shown in FIGS. 12-13, the lock angle 78 may be connected to the fixed frame 22 such that the lock angle 78 extends perpendicular to the X axis. The connection between the lock angle 78 and the fixed frame 22 may be any that secures the lock angle 78 to the fixed frame 22, but by way of example, the connection may be a weld. The lock angle 78 may comprise a lower portion 78a and an upper portion 78b. The lock angle 78 may be tapered towards the upper portion 78b so that the upper portion 78b may be rounded. The lock angle 78 may be connected to the fixed frame 22, as previously described, at the lower portion 78a of the lock angle 78.

The lock angle 78 may be adapted to support the bushing casing 80. The bushing casing 80 may be generally C shaped with a lower connector portion 80a, a side portion 80b, and an upper connector portion 80c. The lower connector portion 80a and the upper connector portion 80c may be generally of the same length. The lower connector portion 80a may have an end portion 80d and the upper connector portion 80c may have an end portion 80e. The end portions may be located at ends of the respective connector portions that are distal from the side portion 80b. The bushing casing 80 may have a receiving opening 82 between the lower connector portion 80a and the upper connector portion 80b. The bushing casing 80 may be fixed to the upper portion 78b of the lock angle 78 at the end portion 80e of the upper connector portion 80c and the end portion 80d of the lower connector portion 80a. The connection may be any that is capable of fixing the bushing casing 80 to the lock angle 78, but by way of example, the connection may be via a weld.

The lower connector portion 80a and the upper connector portion 80c may each have a connecting opening 80f that is capable of receiving a supporting element 84. The supporting element 84 may be a bolt. The connecting openings 80f may be located anywhere on the respective connector portions 80a, 80c such that the connecting openings 80f may be generally aligned so that the supporting element 84 may pass through both connecting openings 80f. By way of example, the connecting opening 80f on the lower connector portion 80a may be centered between the end portion 80d of the lower connector portion 80a and the side portion 80b of the bushing casing 80. Similarly, the connecting opening 80f on the upper connector portion 80c may be centered between the end portion 80e of the upper connector portion 80e and the side portion 80b of the bushing casing 80.

The bushing casing 80 may be adapted to receive the bushing 86. The bushing 86 may be supported by the supporting element 84 within the receiving opening 82 of the bushing casing 80 in a way that allows the bushing 86 to at least slightly extend vertically out of the bushing casing along the Y axis. The bushing 86 may extend along the Z axis, parallel to the side portion 80b of the bushing casing 80. The bushing 86 may be capable of rotating around the supporting element 84 to facilitate smooth traveling of the lock rod flanges 54d.

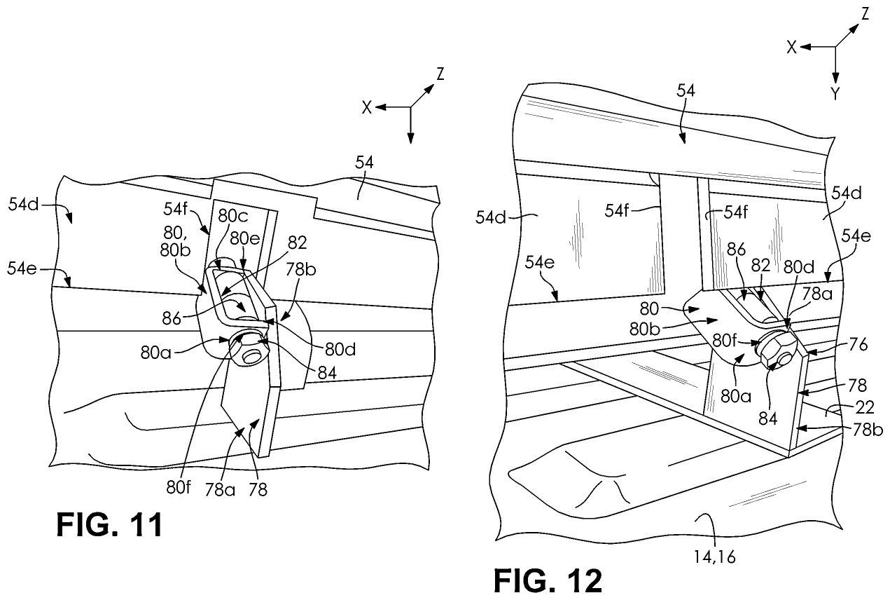

The bushing lock system 76 may work as follows. When the handle 50 is turned, the lock rod 54 and lock rod flanges 54d may rotate out of an initial position and away from the truck bed 14. In the initial position, the lock rod flanges 54d may be perpendicular to the X axis and parallel to the Y axis. Once the slide out tray system 12 begins to extend out of the bed 14, the handle 50 may be released. Once the handle 50 is released, the lock rod flanges 54d may rotate back down towards the truck bed 14. The lock rod flanges 54d may contact the bushing 86 prior to reaching the initial position, as shown in FIG. 12. As the slide out tray system 12 is being extended out of the truck bed 14, a longitudinal side 54e of the lock rod flanges 54d may roll along the bushing 86 in selective contact with the bushing 86 until one of the spaces 54g between the lock rod flanges 54d passes over the bushing 86. With no force being applied to the handle 50, when the bushing 86 meets a space 54g between the lock rod flanges 54d, the lock rod flanges 54d may rotate to the initial position in a way that allows at least a portion of the bushing lock system 76 to enter the space 54g between the lock rod flanges 54d, as shown in FIG. 11. The lateral side 54f of one of the lock rod flanges 54 may then selectively contact the lock angle 78 in a way that prevents further extension of the lock rod 54, and thus the slide out tray system 12. In other words, once the lateral side 54f of one of the lock rod flanges 54 contacts the lock angle 78, the slide out tray system becomes stationary.

In accordance with the provisions of the patent statutes, the present device and/or method has been described in what is considered to represent its preferred embodiments. However, it should be noted that the present device and/or method can be practiced otherwise than as specifically illustrated and described without departing from its spirit or scope.

| | |
|---|---|
| 10 | Vehicle/Truck |
| 12 | Slide out tray system |
| 14 | Truck Bed |
| 16 | Truck Bed Floor |
| 18 | Truck bed Side walls |
| 20 | Wheel wells |
| 22 | Fixed frame |
| 24 | First fixed rail |
| 26 | Second fixed rail |
| 26a | End Portion - Second Fixed Rail |
| 28 | Longitudinal Axis |
| 30 | Lateral Supports - Fixed Frame |
| 32 | First slide frame |
| 34 | First slide rail of First Slide Frame |
| 36 | Second slide rail of First Slide Frame |
| 38 | Lateral Supports - First Slide Frame |
| 40 | Second Slide Frame |
| 42 | First Slide Rail of Second Slide Frame |
| 44 | Second Slide Rail of Second Slide Frame |
| 46 | Perimeter Members |
| 46a | Front Perimeter Member |
| 46b | Rear Perimeter Member |
| 46c | Side Members |
| 48 | Locking System |
| 50 | Handle |
| 52 | Lateral Supports - Second Slide Frame |
| 52a | Distal Lateral Support - Second Slide Frame |
| 52b | Inner Lateral Support - Second Slide Frame |
| 52c | Rear Surface - Inner Lateral Support - Second Slide |
| | Frame |
| 54 | Lock Rod |
| 54a | Lock Rod- First Portion |
| 54b | Lock Rod- Second Portion |
| 54c | Lock Rod - End Surface |
| 54d | Lock Rod Flange |
| 54e | Lock Rod Flange - Longitudinal Side |
| 54f | Lock Rod Flange - Lateral Side |
| 54g | Lock Rod Flange - Spaces |
| 56 | Support Tubes |
| 58 | Cam |
| 58a | Cam Face |
| 58b | Cam - Lower Inboard Surface |
| 58c | Cam - Upper Surface/Upper Portion |
| 58d | Cam- Inboard base portion |
| 58e | Cam- Outboard point portion |
| 60 | Cam Guard |
| 62 | Lock Bar Lever |
| 62a | Offset Position - Lock Bar Lever |
| 62b | Midline - Lock Bar Lever |
| 62c | Inboard Portion - Lock Bar Lever |
| 62d | Outboard Portion - Lock Bar Lever |
| 62e | Outboard Wall - Outboard Portion - Lock Bar Lever |
| 62f | Inboard Wall - Inboard Portion - Lock Bar Lever |
| 62g | Lower Wall - Outboard Portion - Lock Bar Lever |
| 62h | Forward Surface - Lock Bar Lever |
| 62i | Rear Surface - Lock Bar Lever |
| 62j | Lower Surface - Inboard Portion - Lock Bar Lever |
| 64 | Fastener |
| 66 | Locking Plate |
| 66a | First Portion - Locking Plate |
| 66b | Upper Surface - First Portion - Locking Plate |
| 66c | Rear End Portion - First Portion - Locking Plate |
| 66d | Front End Portion - Upper Surface - First Portion - |
| | Locking Plate |
| 66e | Second Portion - Locking Plate |
| 68 | Hinge |
| 70 | Anchor Frame |
| 72 | Lock Bar Lever Flange |
| 74 | Skid Plate |
| 76 | Bushing Lock System |
| 78 | Lock Angle |
| 78a | Lower Portion - Lock Angle |
| 78b | Upper Portion - Lock Angle |
| 80 | Bushing Casing |
| 80a | Lower Connector Portion - Bushing Casing |
| 80b | Side Portion - Bushing Casing |
| 80c | Upper Connector Portion - Bushing Casing |
| 80d | End Portion - Lower Connector Portion - Bushing |
| | Casing |
| 80e | End Portion - Upper Connector Portion - Bushing |
| | Casing |
| 80f | Connecting Openings - Connector Portions - Bushing |
| | Casings |
| 82 | Receiving Opening |
| 84 | Supporting Element |
| 86 | Bushing |

What is claimed is:

1. A locking mechanism for a slide out tray system, comprising;
a cam,
wherein said cam is directly connected to and extends perpendicular to a lock rod,
wherein said lock rod comprises multiple lock rod flanges that are rectangular, planar with one another, and spaced apart from one another along the lock rod,
a lock bar lever,
wherein said lock bar lever comprises an inboard portion and an outboard portion,
wherein the inboard portion of the lock bar lever comprises a lock bar lever flange,
wherein a lower wall of the outboard portion of the lock bar lever is in pivotable contact with an upper portion of the cam, and
a locking plate,
wherein said locking plate comprises a first portion and a second portion,
wherein said first portion comprises a front-end portion and a rear-end portion,
wherein the first portion of the locking plate comprises an upper surface and a lower surface,
wherein the lock bar lever flange is adapted to make contact with the upper surface of the first portion at the front-end portion of the locking plate, and
wherein the rear end portion of the first portion is pivotably attached to the second portion of the locking plate via a spring hinge.

2. The locking mechanism of claim 1, wherein the first portion of the locking plate is angled upward toward a Y axis and the second portion of the locking plate is planar in an X plane and a Z plane.

3. The locking mechanism of claim 1, wherein an upper portion of the cam is arc shaped.

4. The locking mechanism of claim 1, wherein the inboard portion and the outboard portion of the lock bar lever are separated by a midline of the lock bar lever.

5. The locking mechanism of claim 1, wherein the lock bar lever is tapered toward the inboard portion.

6. The locking mechanism of claim 4, wherein said lock bar lever is pivotable about an offset position that is on the inboard portion of the lock bar lever.

7. The locking mechanism of claim 1, wherein the lock bar lever flange is located on a lower surface of the inboard portion of the lock bar lever.

8. The locking mechanism of claim 1, wherein the second portion of the locking plate is fixed to an anchor frame.

9. The locking mechanism of claim 8, wherein the anchor frame is part of the fixed frame, and the fixed frame is fixed to a truck bed.

10. The locking mechanism of claim 1, further comprising a skid plate that is perpendicular to the lock bar lever and parallel to the first portion of the locking plate along an X axis.

11. The locking mechanism of claim 10, wherein the first portion of the locking plate is adapted to make selective contact with the skid plate.

12. The locking mechanism of claim 1, further comprising a bushing lock that is adapted to selectively contact long edges and short edges of the lock rod flanges.

13. The locking mechanism of claim 12, wherein the slide out tray system is in a sliding position when the bushing lock is in contact with the long edges and the slide out tray system is in a locked position when the bushing is in contact with the short edges.

14. A locking mechanism for a slide out tray system, comprising:
a cam,
wherein said cam is directly connected to a lock rod,
wherein said cam comprises a cam face and a covered cam face that are parallel to one another,
wherein said cam comprises an arced upper portion, and
a lock bar lever,
wherein said lock bar lever comprises an inboard portion and an outboard portion,
wherein the outboard portion comprises a lower wall,
wherein the lower wall of the lock bar lever is in pivotable contact with the arced upper portion of the cam.

15. A locking mechanism for a slide out tray system, comprising:
a lock bar lever,
wherein the lock bar lever comprises a lock bar lever flange on a tapered, inboard portion of the lock bar lever, and
a locking plate,
wherein said locking plate comprises a first portion and a second portion,
wherein said first portion of the locking plate comprises a front-end portion and a rear end portion,
wherein the first portion of the locking plate is connected at the rear-end portion to the second portion of the locking plate via a spring hinge,
wherein the first portion of the locking plate is angled upward toward the Y axis relative to the second portion of the locking plate,
wherein the lock bar lever flange is adapted to make selective contact with the front-end portion of the first portion of the locking plate.

16. A locking mechanism for a slide out tray system, comprising:
a lock rod,
wherein said lock rod is rotatable and comprises rectangular lock rod flanges that are cantilevered from the lock rod,
wherein said rectangular lock rod flanges comprise a plurality of long edges that are parallel to an X axis and a plurality of short edges that are perpendicular to the X axis,
wherein the lock rod flanges are arranged on the lock rod such that spaces exist between each lock rod flange,
a bushing,
a bushing casing,
wherein said bushing casing is directly attached to an upper portion of a lock angle,
wherein said bushing casing is adapted to receive a supporting element,
wherein said supporting element supports the bushing,
wherein the long edges of the lock rod flanges are adapted to make slidable contact with the bushing,
wherein the short edges of the lock rod flanges are adapted to make stationary contact with the upper portion of the lock angle when the long edges of the lock rod flanges are not in contact with the bushing.

17. The locking mechanism of claim 16, wherein said supporting element is a bolt.

18. The locking mechanism of claim 16, wherein the lock rod flanges are planar with one another.

19. The locking mechanism of claim 16, wherein the lock angle is rigid and fixed to a fixed frame.

20. The locking mechanism of claim 16, wherein the lock angle extends longitudinally perpendicular to the X axis.

21. The locking mechanism of claim 16, wherein the slide out tray system comprises a fixed frame that is adapted to be fixed to a vehicle bed, a first slide frame, and a second slide frame, wherein the vehicle bed comprises a terminal end, and wherein the second slide frame is adapted to be moved beyond the terminal end and locked by the lock rod.
